(19) United States
(12) Patent Application Publication
(10) Pub. No.: US 2026/0030719 A1
(43) Pub. Date: Jan. 29, 2026

(54) IMAGE PROCESSING DEVICE AND METHOD FOR PROCESSING IMAGE SIGNAL

(71) Applicant: SK hynix Inc., Gyeonggi-do (KR)

(72) Inventors: Ji Hee HAN, Gyeonggi-do (KR); Ju Hyun CHO, Gyeonggi-do (KR)

(21) Appl. No.: 19/048,977

(22) Filed: Feb. 10, 2025

(30) Foreign Application Priority Data
Jul. 25, 2024 (KR) 10-2024-0098625

(51) Int. Cl. G06T 3/40; G06T 3/18; G06T 5/70; G06V 10/74

(52) U.S. Cl. CPC G06T 3/40; G06T 3/18; G06T 5/70; G06V 10/761

(57) ABSTRACT

An image processing device and method are disclosed. The image processing device includes a first image generator configured to generate a first image and a second image using an input image; a reference area detector configured to search for a first reference area most similar to a target area of the input image in the first image, and search for a second reference area most similar to the target area in the second image; a correction area determiner configured to determine a target correction area that is more similar to the target area from among a first correction area located in an area corresponding to the first reference area of the input image and a second correction area located in an area corresponding to the second reference area of the input image; and a second image generator configured to generate a third image using the target correction area.

### CROSS-REFERENCE TO RELATED APPLICATION

This patent application claims the priority and benefits of Korean patent application No. 10-2024-0098625, filed on Jul. 25, 2024, the disclosure of which is incorporated herein by reference in its entirety.

### TECHNICAL FIELD

The technology and embodiments disclosed in the present disclosure generally relate to a processing device, and more particularly to an image processing device that increases a resolution of an input image to generate a high-resolution image.

### BACKGROUND

An image sensing device captures optical images by converting light into electrical signals using a photosensitive semiconductor material which reacts to light. With the development of automotive, medical, computer and communication industries, the demand for high-performance image sensing devices is increasing in various fields such as smartphones, digital cameras, game machines, Internet of Things (IoT), robots, security cameras and medical micro cameras.

In order to increase a resolution of an optical image captured by the image sensing device during image processing of the optical image, an external database (DB) may be used or other images excluding the optical image captured by the image sensing device may be used, so that various operations for increasing the resolution of the optical image can be performed.

### SUMMARY

Various embodiments of the present disclosure relate to an image processing device capable of improving the resolution of an input image.

Various embodiments of the present disclosure relate to an image processing device capable of generating a higher-resolution image using data of an input image.

In accordance with an embodiment of the present disclosure, an image processing device may include a first image generator configured to generate a first image and a second image using an input image; a reference area detector configured to search for a first reference area in the first image and a second reference area in the second image, the first reference area most similar to a target area of the input image in the first image, the second reference area most similar to the target area in the second image; a correction area determiner configured to determine a target correction area from among a first correction area and a second correction area, wherein the target correction area is more similar to the target area, the first correction area is located in an area corresponding to the first reference area of the input image, and the second correction area is located in an area corresponding to the second reference area of the input image; and a second image generator configured to generate a third image using the target correction area.

In accordance with another embodiment of the present disclosure, a method for processing an image signal may include generating a first image and a second image using an input image; searching for a first reference area in the first image and a second reference area in the second image, wherein the first reference area is most similar to a target area of the input image in the first image, and the second reference area is most similar to the target area in the second image; determining a target correction area from among a first correction area and a second correction area, wherein the target correction area is more similar to the target area, the first correction area is located in an area corresponding to the first reference area of the input image, and the second correction area is located in an area corresponding to the second reference area of the input image; and generating a third image using the target correction area.

In accordance with another embodiment of the present disclosure, an image processing device may include a first image generator configured to generate a low-resolution image using an input image; a reference area detector configured to search for a reference area in the low-resolution image, wherein the reference area is similar to a target area of the input image; a similarity determiner configured to determine a similarity between the target area and a correction area located at a coordinate that is obtained by multiplying a scaling coefficient by low-resolution image coordinates of the reference area from among coordinates of the input image; and a second image generator configured to generate a high-resolution image using the correction area based on the similarity between the target area and the correction area.

It is to be understood that both the foregoing general description and the following detailed description of the present disclosure are illustrative and descriptive and are intended to provide further description of the embodiments of the present disclosure as claimed.

### BRIEF DESCRIPTION OF THE DRAWINGS

The above and other features and beneficial aspects of the embodiments of the present disclosure will become readily apparent with reference to the following detailed description when considered in conjunction with the accompanying drawings.

FIG. 1 is a block diagram illustrating an image processing device according to the embodiments of the present disclosure.

FIGS. 2A and 2B are block diagrams illustrating detailed configurations of the image processing device according to the embodiments of the present disclosure.

FIG. 2C is a block diagram illustrating a second image generator according to the embodiments of the present disclosure.

FIG. 3 is a diagram illustrating a method for generating a low-resolution image according to the embodiments of the present disclosure.

FIG. 4 is a flowchart illustrating a method for controlling the image processing device according to the embodiments of the present disclosure.

FIG. 5 is a diagram illustrating a method for generating a high-resolution image according to the embodiments of the present disclosure.

FIG. 6 is a diagram illustrating a state in which the high-resolution image generation method is applied to an actual image according to the embodiments of the present disclosure.

FIG. 7 is a diagram illustrating a target area, a reference area, and a correction area according to the embodiments of the present disclosure.

FIG. 8 is a block diagram showing a computing device corresponding to the image processing device of FIG. 1.

### DETAILED DESCRIPTION

The present disclosure provides embodiments and examples of an image processing device that increases a resolution of an input image to generate a high-resolution image, and a method for processing the image signal, that can perform image conversion that may be used in configurations to substantially address one or more technical or engineering issues and to mitigate limitations or disadvantages encountered in some image processing devices in the art. Some embodiments of the present disclosure relate to an image processing device capable of improving the resolution of an input image. Some embodiments of the present disclosure relate to an image processing device capable of generating a higher-resolution image using data of an input image. In recognition of the issues above, the image processing device can generate a high-resolution image based on a single input image and a low-resolution image generated from the single input image, and can generate a high-quality high-resolution image without using a separate external database (DB). Even in a high-resolution image, detail components of the high-resolution image can be well preserved, and an excellent-performance super-resolution (SR) effect having no mis-corrections or no color defects can be obtained.

Reference will now be made in detail to some embodiments of the present disclosure, examples of which are illustrated in the accompanying drawings. Wherever possible, the same reference numbers will be used throughout the drawings to refer to the same or like parts. While this disclosure is susceptible to various modifications and alternative forms, specific embodiments thereof are shown by way of example in the drawings. However, this disclosure should not be construed as being limited to the embodiments set forth herein.

Hereinafter, various embodiments will be described with reference to the accompanying drawings. However, it should be understood that the present disclosure is not limited to specific embodiments, but includes various modifications, equivalents and/or alternatives of the embodiments. The embodiments of the present disclosure may provide a variety of effects capable of being directly or indirectly recognized through the present disclosure.

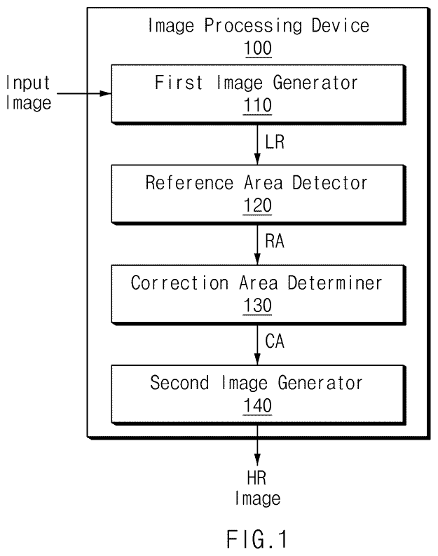

FIG. 1 is a block diagram illustrating an image processing device 100 according to an embodiment of the present disclosure.

Referring to FIG. 1, the image processing device 100 may include a first image generator 110, a reference area detector 120, a correction area determiner 130, and a second image generator 140. In one embodiment, the image processing device 100 may perform at least one image signal processing on an input image to generate high-resolution (HR) image data. The constituent components of the image processing device 100 are merely an example, and some components may be merged into, added to, or omitted from the image processing device 100. For example, the first image generator 110 and the second image generator 140 may be merged into a single module (e.g., a single image generator). For example, the first image generator 110 may be omitted from the image processing device 100, and the image processing device 100 may receive an input image or a low-resolution (LR) image from an external device (e.g., an external server). In one embodiment, the first image generator 110 may correspond to a low-resolution image generator that generates a low-resolution (LR) image, and the second image generator 140 may correspond to a high-resolution image generator that generates a high-resolution (HR) image.

According to an embodiment, the image processing device 100 may compress image data that has been created by execution of image signal processing for image-quality improvement, such that the image processing device 100 can create an image file using the compressed image data. Alternatively, the image processing device 100 may recover image data from the image file. In some embodiments, the scheme for compressing such image data may be a reversible format or an irreversible format. As a representative example of such compression format, in the case of using a still image, Joint Photographic Experts Group (JPEG) format, JPEG 2000 format, or the like can be used. In the case of using moving images, a plurality of frames can be compressed according to Moving Picture Experts Group (MPEG) standards such that moving image files can be created.

According to an embodiment, the image processing device 100 may use a single image super-resolution (SISR) method, a multi-image super-resolution (MISR) method, and/or a video super-resolution (VSR) method to convert a low-resolution image into a high-resolution image. For example, the image processing device 100 may apply the SISR method to a single input image without using the external database, and may thus generate a higher-resolution image than the input image. In one embodiment, the input image may correspond to image data generated by the image sensing device.

The input image may be generated by the image sensing device that captures an optical image of a scene, but the scope of the present disclosure is not limited thereto. The image sensing device may include a pixel array including a plurality of pixels configured to sense incident light received from a scene, a control circuit configured to control the pixel array, and a readout circuit configured to output digital input image by converting an analog pixel signal received from the pixel array into the digital input image. In some embodiments, the input image is generated by the image sensing device and the image processing device 100 receives the input image.

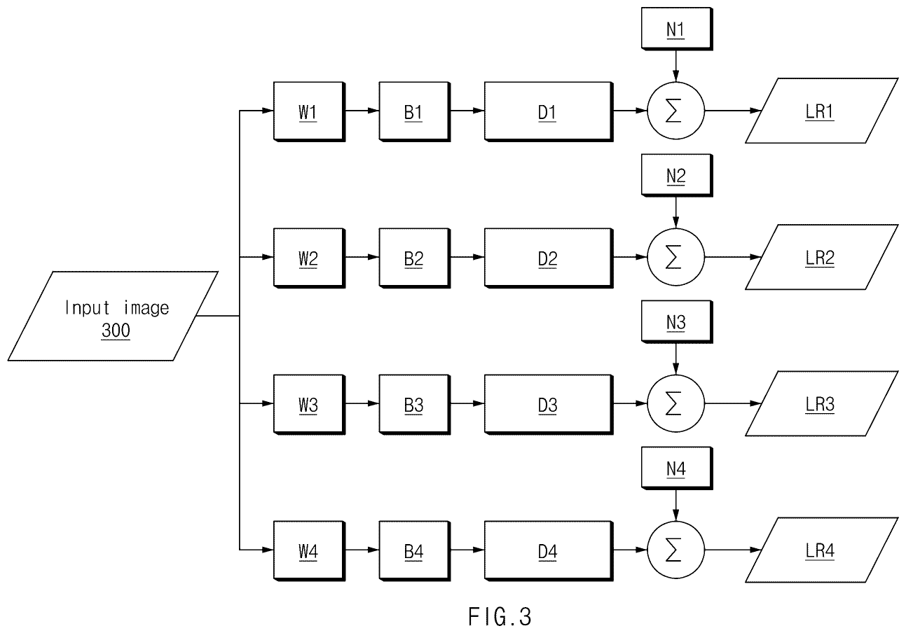

According to an embodiment, the first image generator 110 may receive an input image, and may generate a low-resolution image LR. In one embodiment, the low-resolution image LR may correspond to an image obtained when downscaling is applied to the input image. For example, the downscaling may include at least one of warping, blurring, or downsampling. A more detailed description of the operations of the first image generator 110 will be given later with reference to FIG. 3.

According to an embodiment, the reference area detector 120 may receive a low-resolution image LR, and may generate reference area data RA. In the present disclosure, a certain area may be at least a portion of an image, and the certain area data may include data for the certain area. The data for the certain area may include coordinates and pixel data of each pixel included in the certain area. For example, reference area data RA1_1 may include data for the 1_1 reference area, and the data for the 1_1 reference area may include coordinate and pixel data of each of the pixels included in the 1_1 reference area.

According to an embodiment, the reference area data RA may include coordinates and pixel data of each pixel included in the reference area. In one embodiment, the reference area may correspond to an area that is most similar to a target area of the input image from among constituent areas of the low-resolution image LR. In one embodiment, the target area may correspond to, from among areas of the input image, a subject area, a resolution of which is to be improved. For example, the image processing device 100 may determine, as the target area, a portion of the areas of the input image. In one embodiment, the image processing device 100 may divide the input image 500 into one or more areas, and may determine at least one of the one or more areas to be the target area 502.

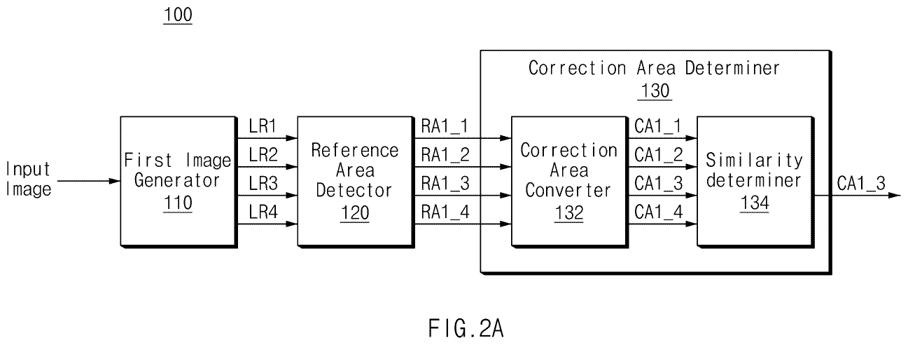

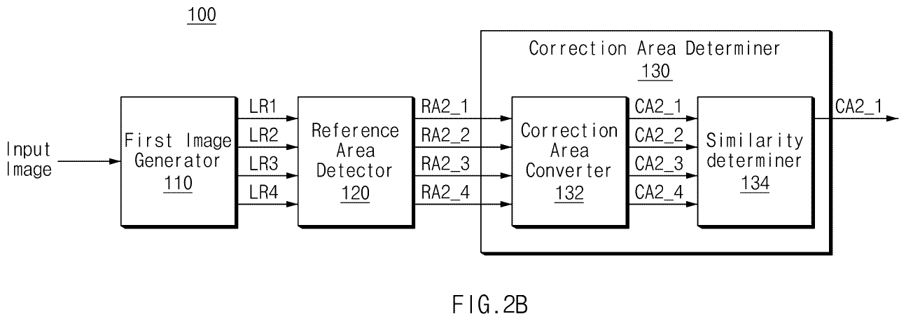

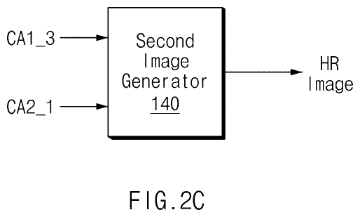

According to an embodiment, the reference area detector 120 may search for a reference area that is most similar to the target area among the areas of the low-resolution image LR based on a sum of absolute difference (SAD) method, a normalized cross correlation (NCC) method, or a mean square error (MSE) method. A more detailed description of the operations of the reference area detector 120 will be given later with reference to FIGS. 2A and 2B.

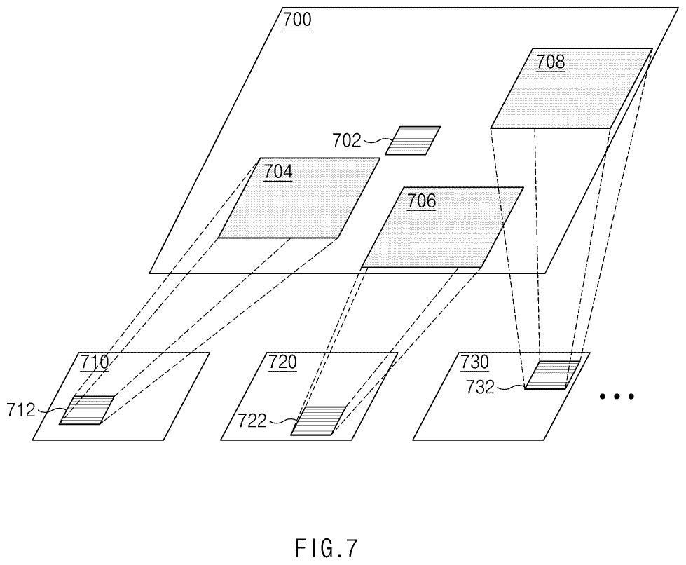

According to an embodiment, the correction area determiner 130 may receive reference area data RA, and may generate correction area data CA. In one embodiment, the correction area data CA may include coordinates and pixel data of each pixel included in the correction area. In one embodiment, the correction area may correspond to an area located in an area of the input image that corresponds to the reference area. In one embodiment, the correction area determiner 130 may determine a target correction area that is more similar to the reference area from among the first correction area corresponding to the first low-resolution image and the second correction area corresponding to the second low-resolution image. In one embodiment, the correction area determiner 130 may determine, as the target correction area, a correction area that is more similar to the reference area from among the first correction area and the second correction area, and may transmit the determined target correction area to the second image generator 140. A more detailed description of the operations of the correction area determiner 130 will be given later with reference to FIG. 7.

According to an embodiment, the second image generator 140 may receive the correction area data CA, and may generate a high-resolution image (HR image). In one embodiment, some areas of the high-resolution image (HR image) may be generated based on at least one correction area datum CA. For example, the second image generator 140 may configure the high-resolution image (HR image) by combining the first to tenth correction areas. A more detailed description of the operations of the second image generator 140 will be given later with reference to FIG. 2C.

According to an embodiment, the first image generator 110 may generate the first image and the second image, and the second image generator 140 may generate the third image. In one embodiment, the first image and the second image may have a lower resolution than the third image.

FIGS. 2A and 2B are block diagrams illustrating detailed configurations of the image processing device 100 according to the embodiments of the present disclosure.

Referring to FIG. 2A, the image processing device 100 may include a first image generator 110, a reference area detector 120, and a correction area determiner 130. In one embodiment, the image processing device 100 may receive an input image including a first target area, and may generate data (e.g., CA1_3 which is described below) corresponding to a correction area that is most similar to the first target area by using the first image generator 110, the reference area detector 120, and the correction area determiner 130. In one embodiment, the correction area most similar to the first target area (e.g., the 1_3 correction area which is described below) may correspond to the first target correction area. In FIG. 2A, the image processing device 100 determines the first target area from among areas of the input image. For example, the image processing device 100 may determine the first target area from among areas of an input image, may generate data (e.g., CA1_3) corresponding to the correction area most similar to the first target area, and may generate an area corresponding to the first target area from among areas of a high-resolution image (HR image) based on the correction area (e.g., the 1_3 correction area) most similar to the first target area.

According to an embodiment, the first image generator 110 may receive the input image, and may generate a first low-resolution image LR1, a second low-resolution image LR2, a third low-resolution image LR3, and a fourth low-resolution image LR4. In an embodiment of the present disclosure, the first image generator 110 generates four low-resolution images (e.g., LR1, LR2, LR3, LR4) for the input image for convenience of description, but the number of low-resolution images is not limited thereto. For example, the first image generator 110 may receive the input image, and may generate first to tenth low-resolution images.

According to an embodiment, the first image generator 110 may generate the first low-resolution image LR1 by applying first downscaling to the input image. The first image generator 110 may generate a second low-resolution image LR2 by applying second downscaling to the input image. The third low-resolution image LR3 and the fourth low-resolution image LR4 may also be generated in the same manner as the first and second low-resolution images.

According to an embodiment, the reference area detector 120 may receive low-resolution images (e.g., LR1, LR2, LR3, and/or LR4), and may generate reference area data (e.g., RA1_1, RA1_2, RA1_3, and/or RA1_4). In FIGS. 2A and 2B, the reference area detector 120 receives four low-resolution images and generates data for four reference areas, but the number of low-resolution images and the number of reference areas data are not limited thereto. In one embodiment, the reference area may be represented by ‘RAm_n’. In this case, the input image may include M target areas, where M may correspond to one of numbers from 1 to M. In addition, N low-resolution images may be generated for the input image, where N may correspond to one of numbers from 1 to N. That is, the (m_n)-th reference area may be represented by ‘RAm_n’, and ‘RAm_n’ may correspond to an area searched for as a reference area that is most similar to the m-th target area by the reference area detector 120 from among the areas of the n-th low-resolution image.

According to an embodiment, the reference area detector 120 may generate reference area data RA1_1, reference area data RA1_2, reference area data RA1_3, and reference area data RA1_4 based on the results of comparing the first target area of the input image with each of the first low-resolution image LR1, the second low-resolution image LR2, the third low-resolution image LR3, and the fourth low-resolution image LR4. 1_1 reference area, 1_2 reference area, 1_3 reference area, and 1_4 reference area, and reference area data RA1_1, reference area data RA1_2, reference area data RA1_3, and reference area data RA1_4 are described below.

According to an embodiment, the reference area detector 120 may search for, among areas of the first low-resolution image LR1, an area that is most similar to the first target area, may identify the 1_1 reference area, and may transmit the reference area data RA1_1 to the correction area converter 132. In one embodiment, the reference area detector 120 may search for, among areas of the second low-resolution image LR2, an area that is most similar to the first target area, may identify the 1_2 reference area, and may transmit the reference area data RA1_2 to a correction area converter 132 of the correction area determiner 130. In one embodiment, the reference area detector 120 may search for, among areas of the third low-resolution image LR3, an area that is most similar to the first target area, may identify the 1_3 reference area, and may transfer the reference area data RA1_3 to the correction area converter 132. In one embodiment, the reference area detector 120 may search for, among areas of the fourth low-resolution image LR4, an area that is most similar to the first target area, may identify the 1_4 reference area, and may transmit the reference area data RA1_4 to the correction area converter 132.

According to an embodiment, the size (area) of the reference area (e.g., the 1_1 reference area, the 1_2 reference area, the 1_3 reference area, and/or the 1_4 reference area) may be equal to the size (area) of the first target area. For example, if the first target area is a rectangular area that includes, as vertices, the points respectively located at (6,7), (6,6), (7,6), and (7,7) among the coordinates of the input image, the 1_1 reference area may correspond to a rectangular area that includes, as vertices, the points respectively located at (1,2), (1,1), (2,1), and (2,2) among the coordinates of the first low-resolution image LR1. Further, the 1_2 reference area may correspond to a rectangular area that includes, as vertices, the points respectively located at (0,1), (0,0), (1,0), and (1,1) among the coordinates of the second low-resolution image LR2. Further, the 1_3 reference area may correspond to a rectangular area that includes, as vertices, the points respectively located at (5,6), (5,5), (6,5), and (6,6) among the coordinates of the third low-resolution image LR3. Further, the 1_4 reference area may correspond to a rectangular area that includes, as vertices, the points respectively located at (0,11), (0,10), (1,10), (1,11) among the coordinates of the fourth low-resolution image LR4.

According to an embodiment, the reference area detector 120 may use the sum of absolute difference (SAD) method, the zeros-mean version SAD (ZSAD) method, the normalized cross correlation (NCC) method, and/or the zero-version NCC (ZNCC) method to search for a reference area (e.g., the 1_1 reference area, the 1_2 reference area, the 1_3 reference area, and/or the 1_4 reference area) that is most similar to the first target area among areas of the low-resolution image (e.g., LR1, LR2, LR3, and/or LR4). In one embodiment, the reference area detector 120 may compare a mean square error (MSE) average value of pixel data of pixels included in the first target area with an MSE average value of pixel data of pixels included in an area having the same size as the first target area among areas of the low-resolution image (e.g., LR1, LR2, LR3, and/or LR4), and may search for an area having the smallest difference based on the result of comparison.

According to an embodiment, the correction area determiner 130 may include the correction area converter 132 and a similarity determiner 134. In one embodiment, the correction area determiner 130 may receive the reference area data RA1_1, the reference area data RA1_2, the reference area data RA1_3, and the reference area data RA1_4, and may identify a correction area (e.g., the 1_3 correction area) that is most similar to the first target area using the correction area converter 132 and the similarity determiner 134.

According to an embodiment, the correction area converter 132 may receive the reference area data RA1_1, the reference area data RA1_2, the reference area data RA1_3, and/or the reference area data RA1_4, and may generate the correction area data CA1_1, the correction area data CA1_2, the correction area data CA1_3, and/or the correction area data CA1_4. In one embodiment, the correction area converter 132 may identify a correction area (e.g., the 1_1 correction area, the 1_2 correction area, the 1_3 correction area, and/or the 1_4 correction area) corresponding to a reference area (e.g., the 1_1 reference area, the 1_2 reference area, the 1_3 reference area, and/or the 1_4 reference area) among areas of the input image, and may transmit, to the similarity determiner 134, the identified correction area data (e.g., CA1_1, CA1_2, CA1_3, and/or CA1_4).

According to an embodiment, the 1_1 correction area may correspond to an area located at a coordinate obtained by multiplying a first coefficient by the coordinates of the first low-resolution image LR1 of the 1_1 reference area among the coordinates of the input image. In one embodiment, the first coefficient may correspond to a value obtained by dividing the resolution of the input image by the resolution of the first low-resolution image LR1. For example, if the 1_1 reference area is a rectangular area that includes, as vertices, the points respectively located at (1,2), (1,1), (2,1), and (2,2) among the coordinates of the first low-resolution image (LR1), and the input image has a resolution twice that of the first low-resolution image LR1, the 1_1 correction area may correspond to a rectangular area that includes, as vertices, the points respectively located at (2,4), (2,2), (4,2), and (4,4) among the coordinates of the input image.

According to an embodiment, the 1_2 correction area may correspond to an area located at coordinates obtained by multiplying a first coefficient by coordinates of the second low-resolution image LR2 of the 1_2 reference area from among the coordinates of the input image. In one embodiment, the first coefficient may correspond to a value obtained by dividing the resolution of the input image by the resolution of the second low-resolution image LR2. For example, if the 1_2 reference area is a rectangular area that includes, as vertices, the points respectively located at (0,1), (0,0), (1,0), and (1,1) among the coordinates of the second low-resolution image LR2, and if the input image has a resolution twice that of the second low-resolution image LR2, the 1_2 correction area may correspond to a rectangular area that includes, as vertices, the points respectively located at (0,2), (0,0), (2,0), and (2,2) among the coordinates of the input image.

According to an embodiment, the 1_3 correction area may correspond to an area located at coordinates obtained by multiplying a first coefficient by coordinates of the third low-resolution image LR3 of the 1_3 reference area from among the coordinates of the input image. In one embodiment, the first coefficient may correspond to a value obtained by dividing the resolution of the input image by the resolution of the third low-resolution image LR3. For example, if the 1_3 reference area is a rectangular area that includes, as vertices, the points respectively located at (5,6), (5,5), (6,5), and (6,6) among the coordinates of the third low-resolution image LR3, and if the input image has a resolution twice that of the third low-resolution image LR3, the 1_3 correction area may correspond to a rectangular area that includes, as vertices, the points respectively located at (10,12), (10,10), (12,10), and (12,12) among the coordinates of the input image.

According to an embodiment, the 1_4 correction area may correspond to an area located at coordinates obtained by multiplying a first coefficient by coordinates of the fourth low-resolution image LR4 of the 1_4 reference area from among the coordinates of the input image. In one embodiment, the first coefficient may correspond to a value obtained by dividing the resolution of the input image by the resolution of the fourth low-resolution image LR4. For example, if the 1_4 reference area is a rectangular area that includes, as vertices, the points respectively located at (0,11), (0,10), (1,10), and (1,11) among the coordinates of the fourth low-resolution image LR4, and if the input image has a resolution twice that of the fourth low-resolution image LR4, the 1_4 correction area may correspond to a rectangular area that includes, as vertices, the points respectively located at (0,22), (0,20), (2,20), and (2,22) among the coordinates of the input image.

According to an embodiment, the similarity determiner 134 may receive the correction area data CA1_1, the correction area data CA1_2, the correction area data CA1_3, and the correction area data CA1_4, may determine, as the first target correction area, one correction area most similar to the first target area from among the correction areas corresponding to the received correction area data CA1_1, the received correction area data CA1_2, the received correction area data CA1_3, and the received correction area data CA1_4, and may transmit correction area data corresponding to the determined correction area to the external device (e.g., the second image generator 140).

According to an embodiment, the similarity determiner 134 may down-scale the received correction area (e.g., the 1_1 correction area, the 1_2 correction area, the 1_3 correction area, and/or the 1_4 correction area) to determine the correction area that is most similar to the first target area. In one embodiment, the downscaling of the correction area may include at least one of warping, blurring, or downsampling.

According to an embodiment, the similarity determiner 134 may generate the 1_1 downscaling correction area by performing first downscaling on the 1_1 correction area, may generate the 1_2 downscaling correction area by performing second downscaling on the 1_2 correction area, may generate the 1_3 downscaling correction area by performing third downscaling on the 1_3 correction area, and may generate the 1_4 downscaling correction area by performing fourth downscaling on the 1_4 correction area. In one embodiment, the first to fourth downscalings may correspond to the downscalings applied to generate the first to fourth low-resolution images LR1 to LR4.

According to an embodiment, the similarity determiner 134 may compare pixel data of the first target area with pixel data of each of the 1_1 downscaling correction area, the 1_2 downscaling correction area, the 1_3 downscaling correction area, and the 1-4 downscaling correction area, and may determine the most similar correction area based on a result of comparison. For example, in a situation where the average pixel data value of the first target area is 10, if the average pixel data value of the 1_1 downscaling correction area is 15, the average pixel data value of the 1_2 downscaling correction area is 20, the average pixel data value of the 1_3 downscaling correction area is 7, and the average pixel data value of the 1_4 downscaling correction area is 25, the similarity determiner 134 may determine the 1_3 correction area corresponding to the 1_3 downscaling correction area, as the correction area that is most similar to the first target area. For example, the similarity determiner 134 may determine the 1_3 correction area as the first target correction area, and may transmit the correction area data (CA1_3) to the second image generator 140.

According to an embodiment, the similarity determiner 134 may compare pixel data of the first target area with pixel data of each of the 1_1 correction area, the 1_2 correction area, the 1_3 correction area, and the 1-4 correction area, and may determine the most similar correction area based on a result of comparison. For example, in a situation where the average pixel data value of the first target area is 10, if the average pixel data value of the 1_1 correction area is 15, the average pixel data value of the 1_2 correction area is 20, the average pixel data value of the 1_3 correction area is 7, and the average pixel data value of the 1_4 correction area is 25, the similarity determiner 134 may determine the 1_3 correction area as the correction area that is most similar to the first target area.

According to an embodiment, the similarity determiner 134 may determine the similarity between the first target area and the correction area from among the coordinates of the input image. In one embodiment, when a difference between pixel data of at least one pixel included in the area obtained by downscaling the correction area and the other pixel data of at least one pixel included in the first target area is less than or equal to a preset threshold value, the similarity determiner 134 may determine that the correction area is similar to the first target area.

Referring to FIG. 2B, the image processing device 100 may include a first image generator 110, a reference area detector 120, and a correction area determiner 130. In one embodiment, the image processing device 100 may receive the input image including the second target area, and may generate a correction area (e.g., the 2_1 correction area which is described below) that is most similar to the second target area by using the first image generator 110, the reference area detector 120, and the correction area determiner 130. In FIG. 2B, the image processing device 100 determines the second target area from among the areas of the input image. For example, the image processing device 100 may determine the second target area from among the areas of the input image, may generate the correction area (e.g., the 2_1 correction area) most similar to the second target area, and may generate an area corresponding to the second target area from among the areas of the high-resolution image based on the correction area (e.g., the 2_1 correction area) most similar to the second target area.

According to an embodiment, the second target area may correspond to an area different from the first target area shown in FIG. 2A. In one embodiment, the operation of generating an area corresponding to the first target area from among areas of the high-resolution image (HR image) based on the most similar correction area (e.g., the 1_3 correction area which is described below) that is most similar to the first target area, and the operation of generating an area corresponding to the second target area from among areas of the HR image may be performed simultaneously or sequentially by the image processing device 100.

According to an embodiment, the first image generator 110 may receive the input image, and may generate a first low-resolution image LR1, a second low-resolution image LR2, a third low-resolution image LR3, and a fourth low-resolution image LR4. In the embodiments of the present disclosure, the first image generator 110 generates four low-resolution images (e.g., LR1, LR2, LR3, LR4) for the input image, but the number of low-resolution images (LR images) is not limited thereto. For example, the first image generator 110 may receive the input image, and may generate the first to tenth low-resolution images.

According to an embodiment, the first image generator 110 may generate a first low-resolution image LR1 by applying first downscaling to the input image. The first image generator 110 may generate a second low-resolution image LR2 by applying second downscaling to the input image. The third low-resolution image LR3 and the fourth low-resolution image LR4 may also be generated in the same manner as the second low-resolution image LR2.

According to an embodiment, the reference area detector 120 may receive the first low-resolution image LR1, the second low-resolution image LR2, the third low-resolution image LR3, and the fourth low-resolution image LR4. In one embodiment, the reference area detector 120 may generate the reference area data RA2_1, the reference area data RA2_2, the reference area data RA2_3, and the reference area data RA2_4 based on the results of comparing the second target area of the input image with each of the first low-resolution image LR1, the second low-resolution image LR2, the third low-resolution image LR3, and the fourth low-resolution image LR4.

According to an embodiment, the reference area detector 120 may search for an area similar to the second target area from among the areas of the first low-resolution image LR1 to identify the 2_1 reference area, and may transmit the reference area data RA2_1 to a correction area converter 132 of the correction area determiner 130. In one embodiment, the reference area detector 120 may search for an area similar to the second target area from among the areas of the second low-resolution image LR2 to identify the 2_2 reference area, and may transmit the reference area data RA2_2 to the correction area converter 132. In one embodiment, the reference area detector 120 may search for an area similar to the second target area from among the areas of the third low-resolution image LR3 to identify the 2_3 reference area, and may transmit the reference area data RA2_3 to the correction area converter 132. In one embodiment, the reference area detector 120 may search for an area similar to the second target area from among the areas of the fourth low-resolution image LR4 to identify the 2_4 reference area, and may transmit the reference area data RA2_4 to the correction area converter 132.

According to an embodiment, the size (area) of the reference area (e.g., the 2_1 reference area, the 2_2 reference area, the 2_3 reference area, and/or the 2_4 reference area) may be equal to the size (area) of the second target area. For example, if the second target area is a rectangular area that includes, as vertices, the points respectively located at (1,1), (1,0), (2,0), and (2,1) from among the coordinates of the input image, the 2_1 reference area may correspond to a rectangular area that includes, as vertices, the points respectively located at (3,6), (3,5), (4,5), and (4,6) from among the coordinates of the first low-resolution image LR1. Further, the 2_2 reference area may correspond to a rectangular area that includes, as vertices, the points respectively located at (2,5), (2,4), (3,4), and (3,5) from among the coordinates of the second low-resolution image LR2. Further, the 2_3 reference area may correspond to a rectangular area that includes, as vertices, the points respectively located at (7,10), (7,9), (8,9), and (8,10) from among the coordinates of the third low-resolution image LR3. Further, the 2_4 reference area may correspond to a rectangular area that includes, as vertices, the points respectively located at (2,15), (2,14), (3,14), and (3,15) from among the coordinates of the fourth low-resolution image LR4.

According to an embodiment, the correction area determiner 130 may include the correction area converter 132 and a similarity determiner 134. In one embodiment, the correction area determiner 130 may receive the reference area data RA2_1, the reference area data RA2_2, the reference area data RA2_3, and the reference area data RA2_4, and may identify a correction area (e.g., the 2_1 correction area) that is most similar to the second target area using the correction area converter 132 and the According to an embodiment, the correction area converter 132 may receive the reference area data RA2_1, the reference area data RA2_2, the reference area data RA2_3, and/or the reference area data RA2_4, and may generate the correction area data CA2_1, the correction area data CA2_2, the correction area data CA2_3, and/or the correction area data CA2_4. In one embodiment, the correction area converter 132 may identify a correction area (e.g., the 2_1 correction area, the 2_2 correction area, the 2_3 correction area, and/or the 2_4 correction area) corresponding to reference area data (e.g., RA2_1, RA2_2, RA2_3, and/or RA2_4) among areas of the input image, and may transmit, to the similarity determiner 134, the identified correction area (e.g., the 2_1 correction area, the 2_2 correction area, the 2_3 correction area, and/or the 2_4 correction area).

According to an embodiment, the 2_1 correction area may correspond to an area located at coordinates obtained by multiplying a second coefficient by coordinates of the first low-resolution image LR1 of the 2_1 reference area from among the coordinates of the input image. In one embodiment, the second coefficient may correspond to a value obtained by dividing the resolution of the input image by the resolution of the first low-resolution image LR1. For example, if the 2_1 reference area is a rectangular area that includes, as vertices, the points respectively located at (3,6), (3,5), (4,5), and (4,6) from among the coordinates of the first low-resolution image LR1, and if the input image has a resolution twice that of the first low-resolution image LR1, the 2_1 correction area may correspond to a rectangular area that includes, as vertices, the points respectively located at (6,12), (6,10), (8,10), and (8,12) from among the coordinates of the input image.

According to an embodiment, the 2_2 correction area may correspond to an area located at coordinates obtained by multiplying the second coefficient by coordinates of the second low-resolution image LR2 of the 2_2 reference area from among the coordinates of the input image. In one embodiment, the second coefficient may correspond to a value obtained by dividing the resolution of the input image by the resolution of the second low-resolution image LR2. For example, if the 2_2 reference area is a rectangular area that includes, as vertices, the points respectively located at (2,5), (2,4), (3,4), and (3,5) from among the coordinates of the second low-resolution image LR2, and if the input image has a resolution twice that of the second low-resolution image LR2, the 2_2 correction area may correspond to a rectangular area that includes, as vertices, the points respectively located at (4,10), (4,8), (6,8), and (6,10) from among the coordinates of the input image.

According to an embodiment, the 2_3 correction area may correspond to an area located at coordinates obtained by multiplying the second coefficient by coordinates of the third low-resolution image LR3 of the 2_3 reference area from among the coordinates of the input image. In one embodiment, the second coefficient may correspond to a value obtained by dividing the resolution of the input image by the resolution of the third low-resolution image LR3. For example, if the 2_3 reference area is a rectangular area that includes, as vertices, the points respectively located at (7,10), (7,9), (8,9), and (8,10) from among the coordinates of the third low-resolution image LR3, and if the input image has a resolution twice that of the third low-resolution image LR3, the 2_3 correction area may correspond to a rectangular area that includes, as vertices, the points respectively located at (14,20), (14,18), (16,18), and (16,20) from among the coordinates of the input image.

According to an embodiment, the 2_4 correction area may correspond to an area located at coordinates obtained by multiplying the second coefficient by coordinates of the fourth low-resolution image LR4 of the 2_4 reference area from among the coordinates of the input image. In one embodiment, the second coefficient may correspond to a value obtained by dividing the resolution of the input image by the resolution of the fourth low-resolution image LR4. For example, if the 2_4 reference area is a rectangular area that includes, as vertices, the points respectively located at (2,15), (2,14), (3,14), and (3,15) from among the coordinates of the fourth low-resolution image LR4, and if the input image has a resolution twice that of the fourth low-resolution image LR4, the 2_4 correction area may correspond to a rectangular area that includes, as vertices, the points respectively located at (4,30), (4,28), (6,28), and (6,30) from among the coordinates of the input image. In one embodiment, referring also to FIG. 2A, the second coefficient may have the same value as the first coefficient.

According to an embodiment, the similarity determiner 134 may receive the correction area data CA2_1, the correction area data CA2_2, the correction area data CA2_3, and the correction area data CA2_4, may determine, as the second target correction area, the area most similar to the second target area from among the correction areas corresponding to the received correction area data CA2_1, the received correction area data CA2_2, the received correction area data CA2_3, and the received correction area data CA2_4, and may transmit the determined result to the external device (e.g., the second image generator 140).

According to an embodiment, the similarity determiner 134 may down-scale the received correction areas (e.g., the 2_1 correction area, the 2_2 correction area, the 2_3 correction area, and/or the 2_4 correction area) to determine a correction area that is most similar to the second target area. In one embodiment, the similarity determiner 134 may generate the 2_1 downscaling correction area by performing first downscaling on the 2_1 correction area, may generate the 2_2 downscaling correction area by performing second downscaling on the 2_2 correction area, may generate the 2_3 downscaling correction area by performing third downscaling on the 2_3 correction area, and may generate the 2_4 downscaling correction area by performing fourth downscaling on the 2_4 correction area.

According to an embodiment, the similarity determiner 134 may determine the most similar correction area based on a result of comparing pixel data of the second target area with pixel data of each of the 2_1 downscaling correction area, the 2_2 downscaling correction area, the 2_3 downscaling correction area, and the 2_4 downscaling correction area. For example, if the average pixel data value of the second target area is zero “0”, and if the average pixel data value of the 2_1 downscaling correction area is 5, the average pixel data value of the 2_2 downscaling correction area is 20, the average pixel data value of the 2_3 downscaling correction area is 10, and the average pixel data value of the 2_4 downscaling correction area is 25, the similarity determiner 134 may determine the 2_1 correction area corresponding to the 2_1 downscaling correction area, as the correction area that is most similar to the second target area. For example, the similarity determiner 134 may determine the 2_1 correction area as the second target correction area, and may transmit the correction area data CA2_1 to the second image generator 140.

According to an embodiment, the similarity determiner 134 may determine the most similar correction area based on a result of comparing pixel data of the second target area with pixel data of each of the 2_1 correction area, the 2_2 correction area, the 2_3 correction area, and the 2_4 correction area. For example, if the average pixel data value of the second target area is 10, and if the average pixel data value of the 2_1 correction area is 15, the average pixel data value of the 2_2 correction area is 20, the average pixel data value of the 2_3 correction area is 0, and the average pixel data value of the 2_4 correction area is 25, the similarity determiner 134 may determine the 2_1 correction area as the correction area that is most similar to the second target area.

According to an embodiment, the similarity determiner 134 may determine the similarity between the second target area and the correction area from among the coordinates of the input image. In one embodiment, when a difference between pixel data of at least one pixel included in the area obtained by downscaling the correction area and the other pixel data of at least one pixel included in the second target area is less than or equal to a preset threshold value, the similarity determiner 134 may determine that the correction area and the second target area are similar to each other.

FIG. 2C is a block diagram illustrating the second image generator 140 according to the embodiments of the present disclosure.

Referring to FIG. 2C, the second image generator 140 may receive the correction area data CA1_3 and/or the correction area data CA2_1, and may generate a high-resolution image (HR image).

In one embodiment, the second image generator 140 may determine an area corresponding to the target area from among the areas of the high-resolution image as a correction area that is most similar to the target area. For example, the second image generator 140 may position a target correction area within an area corresponding to the target area from among areas of the high-resolution image. In FIG. 2C, the second image generator 140 generates the high-resolution image (HR image) based on two correction areas, but the number of correction areas is not limited thereto. For example, the second image generator 140 may receive 10 correction areas based on 10 different target areas, and may position the received 10 correction areas within areas corresponding to the 10 target areas from among the areas of the high-resolution image, resulting in formation of the high-resolution image (HR image).

According to an embodiment, the second image generator 140 may receive the correction area data CA1_3 and/or the correction area data CA2_1, and may combine the 1_3 correction area corresponding to the received correction area data CA1_3 and/or the 2_1 correction area corresponding to the received correction area data CA2_1 to generate a high-resolution image (HR image). In one embodiment, the 1_3 correction area may correspond to a correction area most similar to the first target area based on the operation described in FIG. 2A. For example, the 1_3 correction area may correspond to the first target correction area. In one embodiment, the 2_1 correction area may correspond to a correction area most similar to the second target area based on the operation described in FIG. 2B. For example, the 2_1 correction area may correspond to the second target correction area.

According to an embodiment, the 1_3 correction area may be located at coordinates obtained by multiplying a third coefficient by the coordinates of the input image of the first target area from among the coordinates of the high-resolution image (HR image) that has not been generated yet, and may thus constitute at least a portion of the high-resolution image (HR image). In one embodiment, the third coefficient may correspond to a value obtained by dividing the resolution of the high-resolution image (HR image) by the resolution of the input image. For example, if the first target area is a rectangular area that includes, as vertices, the points respectively located at (6,7), (6,6), (7,6), and (7,7) from among the coordinates of the input image, and the high-resolution image (HR image) has a resolution twice that of the input image, the 1_3 correction area may be located at a rectangular area that includes, as vertices, the points respectively located at (12,14), (12,12), (14,12), and (14,14) of the high-resolution image (HR image) that has not been generated yet, thereby constituting at least a portion of the high-resolution image (HR image).

According to an embodiment, the 2_1 correction area may be located at coordinates obtained by multiplying a third coefficient by the coordinates of the input image of the second target area from among the coordinates of the high-resolution image (HR image) that has not been generated yet, and may thus constitute at least a portion of the high-resolution image (HR image). In one embodiment, the third coefficient may correspond to a value obtained by dividing the resolution of the high-resolution image (HR image) by the resolution of the input image. For example, if the second target area is a rectangular area that includes, as vertices, the points respectively located at (1,1), (1,0), (2,0), and (2,1) from among the coordinates of the input image, and the high-resolution image (HR image) has a resolution twice that of the input image, the 2_1 correction area may be located at a rectangular area that includes, as vertices, the points respectively located at (2,2), (2,0), (4,0), and (4,2) of the high-resolution image (HR image) that has not been generated yet, thereby constituting at least a portion of the high-resolution image (HR image).

FIG. 3 is a diagram illustrating a method for generating a low-resolution image according to the embodiments of the present disclosure.

Referring to FIG. 3, the first image generator 110 may perform downscaling on the input image 300 to generate the low-resolution image (e.g., LR1, LR2, LR3, or LR4). In one embodiment, the downscaling may include the operation of applying at least one of warping (e.g., W1, W2, W3, or W4), blurring (e.g., B1, B2, B3, or B4), or downsampling (e.g., D1, D2, D3, or D4) to the input image 300 and/or the operation of adding noise (e.g., N1, N2, N3, or N4) to the input image 300. In one embodiment of the downscaling operation, the order of warping (e.g., W1, W2, W3, or W4), blurring (e.g., B1, B2, B3, or B4), or downsampling (e.g., D1, D2, D3, or D4) for the input image 300 may be changed.

In one embodiment, the low-resolution image (e.g., LR1, LR2, LR3, or LR4) may satisfy a matrix relationship such as Equation 1. In Equation 1, LR may represent a low-resolution image, CR may represent a reference image, D may represent a downsampling function, B may represent a blurring function, W may represent a warping function, N may represent noise, and n may represent the number of low-resolution images. For example, the input image 300 may be substituted into the reference image (CR).

$$[ \begin{matrix}{LR}_{1} \\ ⋮ \\ {LR}_{n}\end{matrix} ] = [ \begin{matrix}{D}_{1} {B}_{1} {W}_{1} \\ ⋮ \\ {D}_{n} {B}_{n} {W}_{n}\end{matrix} ] CR + [ \begin{matrix}{N}_{1} \\ ⋮ \\ {N}_{n}\end{matrix} ] \qquad [ Equation 1 ]$$

In one embodiment, the warping (e.g., W1, W2, W3, or W4) may include an operation in which pixel positions of the input image are changed. In one embodiment, the warping (e.g., W1, W2, W3, or W4) may include scaling and/or rotation operations.

According to an embodiment, when warping (e.g., W1, W2, W3, or W4) is applied to the input image 300, the coordinates (x, y) of the input image 300 may satisfy matrix relationships such as Equation 2 and Equation 3 below. In Equation 2 and Equation 3, (x) may denote an X-axis coordinate of the input image 300, (y) may correspond to a Y-axis coordinate of the input image 300, (x′) may denote a value obtained when the scaling and rotation operations are performed on the value of x, (y′) may denote a value obtained when the scaling and rotation operations are performed on the value of y, (a) may denote X-component noise, (b) may denote y-component noise, (x_W) may denote a value obtained when the warping operation is performed on the value of x, and (y_W) may denote a value obtained when the warping operation is performed on the value of y.

$$[ \begin{matrix}{x}^{′} \\ {y}^{′}\end{matrix} ] = [ \begin{matrix}cos ∅ & - sin ∅ \\ sin ∅ & cos ∅\end{matrix} ] [ \begin{matrix}a & 0 \\ 0 & b\end{matrix} ] [ \begin{matrix}x \\ y\end{matrix} ] \qquad [ Equation 2 ]$$

$$[ \begin{matrix}x\_W \\ y\_w \\ 1\end{matrix} ] = [ \begin{matrix}1 & 0 & a \\ 0 & 1 & b \\ 0 & 0 & 1\end{matrix} ] [ \begin{matrix}{x}^{′} \\ {y}^{′} \\ 1\end{matrix} ] \qquad [ Equation 3 ]$$

According to an embodiment, blurring (e.g., B1, B2, B3, or B4) may include an operation of filtering pixel data of the input image. In one embodiment, blurring (e.g., B1, B2, B3, or B4) may include an operation of smoothing pixel data of the input image.

According to an embodiment, when blurring (e.g., B1, B2, B3, or B4) is applied to the input image, coordinates (x, y) of the input image may satisfy a relationship such as Equation 4. In Equation 4, f [x, y] may denote an image obtained after blurring is performed, g [k,l] may denote an image obtained before blurring is performed, and h[x,y; k,l] may denote a response value at [x, y] for impulse of a pixel located at [k, l].

$$j [ x , y ] = {\sum }_{k} {\sum }_{l} h [ x , y ; k , l ] g [ k , l ] \qquad [ Equation 4 ]$$

According to an embodiment, downsampling (e.g., D1, D2, D3, or D4) may include an operation of reducing the size of the input image. In one embodiment, downsampling (e.g., D1, D2, D3, or D4) may include an operation of reducing the resolution of the input image.

According to an embodiment, when downsampling (e.g., D1, D2, D3, or D4) is applied to the input image, the input image i[n] may satisfy a relationship such as Equation 5. In Equation 5, i[n] may denote an input image, d[n] may denote an image obtained when downsampling is performed, h[k] may denote an impulse obtained at a coordinate (k), K may denote the length of the impulse, and M may denote a reduction ratio.

$$d [ n ] - {\sum }_{k = 0}^{K - 1} i [ nM - k ] \cdot h [ k ] \qquad [ Equation 5 ]$$

According to an embodiment, the operation of adding noise (e.g., N1, N2, N3 or N4) to the input image may include an operation of adding additive white Gaussian noise (AWGN) and/or shot noise to the input image. In one embodiment, the noise (e.g., N1, N2, N3 or N4) added to the input image may correspond to (a) and/or (b) shown in Equations 2 and 3.

According to an embodiment, the first image generator 110 may generate the first low-resolution image LR1 by performing first downscaling on the input image 300, may generate the second low-resolution image LR2 by performing second downscaling on the input image 300, may generate the third low-resolution image LR3 by performing third downscaling on the input image 300, and may generate the fourth low-resolution image LR4 by performing fourth downscaling on the input image 300.

According to an embodiment, the first downscaling may include the operation of applying at least one of a first warping (W1), a first blurring (B1), and a first downsampling (D1) to the input image 300 and/or the operation of adding a first noise (N1) to the input image 300. In one embodiment, the second downscaling may include the operation of applying at least one of a second warping (W2), a second blurring (B2), and a second downsampling (D2) to the input image 300 and/or the operation of adding a second noise (N2) to the input image 300. The above-described operations may also be equally applied to the third downscaling and the fourth downscaling.

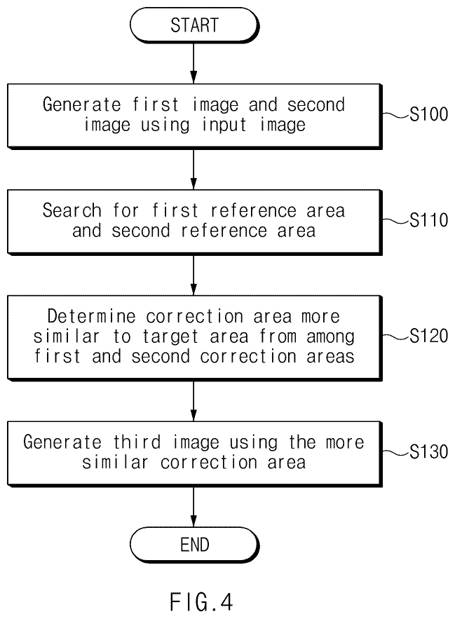

FIG. 4 is a flowchart illustrating a method for controlling the image processing device 100 according to the embodiments of the present disclosure.

Referring to FIG. 4, the image processing device 100 may generate a first image and a second image using the input image (S100). In one embodiment, referring to FIG. 4 together with FIG. 1, the first image generator 110 may generate a first image and a second image. The first image and the second image may correspond to images, each of which has a lower resolution than a third image to be described later. In one embodiment, the first image generator 110 may generate the first image by applying first downscaling to the input image. In addition, the first image generator 110 may generate the second image by applying second downscaling to the input image. In one embodiment, the first image and the second image may correspond to images, each of which is a degraded image that has lower resolution, lower sharpness (sharpness), and/or lower contrast than the input image.

According to an embodiment, the image processing device 100 may search for a first reference area and a second reference area (S110). In one embodiment, the reference area detector 120 of the image processing device 100 may search for an area that is most similar to a target area of the input image from among areas of the first image. In addition, the reference area detector 120 may identify, as the first reference area, the area searched for as the most similar area (that is most similar to the target area). In one embodiment, the reference area detector 120 may search for an area that is most similar to the target area of the input image from among areas of the second image. In addition, the reference area detector 120 may identify, as the second reference area, an area searched for as an area that is most similar to the target area.

According to an embodiment, the image processing device 100 may determine a correction area that is more similar to the target area from among the first correction area and the second correction area (S120). In one embodiment, the correction area determiner 130 may identify the first correction area based on the first reference area, and may identify the second correction area based on the second reference area. In one embodiment, the first correction area may correspond to an area located in an area corresponding to the first reference area from among areas of the input image. Additionally, the second correction area may correspond to an area located in an area corresponding to the second reference area from among areas of the input image. In one embodiment, the correction area determiner 130 may determine a target correction area that is more similar to the target area from among the first correction area (located in an area corresponding to the first reference area from among areas of the input image) and the second correction area (located in an area corresponding to the second reference area from among areas of the input image).

According to an embodiment, the correction area determiner 130 may generate a first downscaling correction area obtained when the first downscaling is performed on the first correction area, and may generate a second downscaling correction area obtained when the second downscaling is performed on the second correction area. The correction area determiner 130 may determine, as a more similar correction area, a correction area (that corresponds to a downscaling correction area determined to be more similar to a target area from among the first downscaling correction area and the second downscaling correction area). For example, the correction area determiner 130 may determine, as a target correction area, a correction area (that corresponds to a downscaling correction area determined to be more similar to the target area from among the first downscaling correction area and the second downscaling correction area).

According to an embodiment, the image processing device 100 may generate a third image using the more similar correction area (S130). In one embodiment, referring to FIG. 4 together with FIG. 1, the second image generator 140 may generate a third image. The third image may correspond to an image having a higher resolution than each of the first image and the second image. In one embodiment, the second image generator 140 may generate the third image using the target correction area. In one embodiment, the third image may correspond to an image having higher resolution, higher sharpness, and/or higher contrast than the input image. In one embodiment, the second image generator 140 may generate the third image using the correction area determined to be a more similar correction area through S120. In one embodiment, the second image generator 140 may generate at least a portion of the third image by positioning the correction area (determined to be a more similar correction area) within an area corresponding to the target area among areas of the third image. In one embodiment, the second image generator 140 may determine an area corresponding to the target area from among the areas of the third image as the more similar correction area that is more similar to the target area.

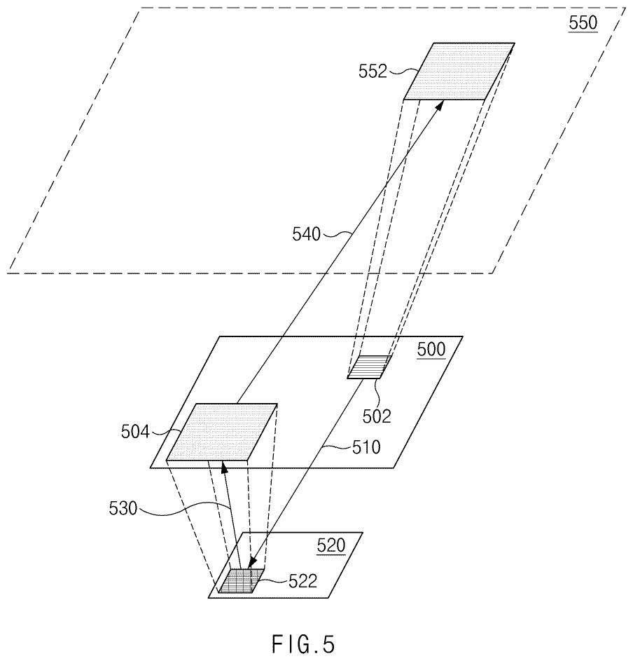

FIG. 5 is a diagram illustrating a method for generating the high-resolution image according to the embodiments of the present disclosure.

Referring to FIG. 5, the image processing device 100 may receive an input image 500 and may determine a target area 502 of the input image 500. In one embodiment, the target area 502 may correspond to an area scheduled to have a higher resolution from among areas of the input image 500. For example, the image processing device 100 may determine at least a portion of the input image 500 as the target area 502. In one embodiment, the image processing device 100 may divide the input image 500 into (N×M) frames, and may determine, as the target area 502, one frame from among the (N×M) frames, where each of N and M may correspond to a natural number. For example, the image processing device 100 may divide the input image 500 into (N×M) frames, may sequentially determine each frame as a target area, and may generate a high-resolution image corresponding to each of the determined target areas, thereby generating a high-resolution image 550 for the entire input image 500.

According to an embodiment, the first image generator 110 of the image processing device 100 may generate a low-resolution image 520 based on the input image 500. For example, the first image generator 110 may downscale the input image 500 to generate the low-resolution image 520.

According to an embodiment, the reference area detector 120 of the image processing device 100 may search for an area most similar to the target area 502 from among the areas of the low-resolution image 520, and may identify the most similar area as the reference area 522 (510).

In one embodiment, the reference area 522 may have the same size as the target area 502. For example, if the target area 502 corresponds to a rectangular area that includes some coordinates (100,100), (100,80), (120,80), and (120,100) from among the coordinates of the input image 500 as vertices, the reference area 522 may correspond to a rectangular area that includes some coordinates (5,25), (5,5), (25,5), and (25,25) from among the coordinates of the low-resolution image 520 as vertices.

According to an embodiment, the correction area determiner 130 of the image processing device 100 may identify, as the correction area 504, an area corresponding to the reference area 522 from among the areas of the input image 500 (530). In one embodiment, the correction area 504 may correspond to an area located at coordinates obtained by multiplying a first coefficient by the coordinates of the low-resolution image 520 of the reference area 522 from among the coordinates of the input image 500. In one embodiment, the first coefficient may correspond to a value obtained by dividing the resolution of the input image 500 by the resolution of the low-resolution image 520. For example, if the first coefficient is 2 and the reference area 522 corresponds to a rectangular area that includes some coordinates (5,25), (5,5), (25,5), and (25,25) from among the coordinates of the low-resolution image 520 as vertices, the correction area 504 may correspond to a rectangular area that includes some coordinates (10,50), (10,10), (50,10), and (50,50) from among the coordinates of the input image 500 as vertices. In FIG. 5, for convenience, the correction area 504 is determined as the correction area most similar to the target area 502.

According to an embodiment, the second image generator 140 of the image processing device 100 may generate at least a portion of the high-resolution image 550 (540) by positioning the correction area 504 within an area 552 corresponding to the target area 502 from among areas of the high-resolution image 550 that have not yet been generated. In one embodiment, the second image generator 140 may determine, as the correction area 504, the area 552 corresponding to the target area 502 from among areas of the high-resolution image 550 that have not yet been generated. In one embodiment, the area 552 corresponding to the target area 502 may correspond to an area located at coordinates obtained by multiplying a third coefficient by the coordinates of the input image 500 of the target area 502 from among coordinates of the high-resolution image 550 that have not yet been generated. In one embodiment, the third coefficient may correspond to a value obtained by dividing the resolution of the high-resolution image 550 by the resolution of the input image 500. For example, if the third coefficient is 2 and the target area 502 corresponds to a rectangular area that includes, as vertices, some coordinates (100,100), (100,80), (120,80), and (120,100) from among the coordinates of the input image 500, the area 552 corresponding to the target area 502 may correspond to a rectangular area that includes, as vertices, some coordinates (200,200), (200,160), (240,160), and (240,200) from among the coordinates of the high-resolution image 550 that has not yet been generated. At this time, the second image generator 140 may copy the correction area 504 to the area 552 corresponding to the target area 502, and may generate at least a portion of the high-resolution image 550.

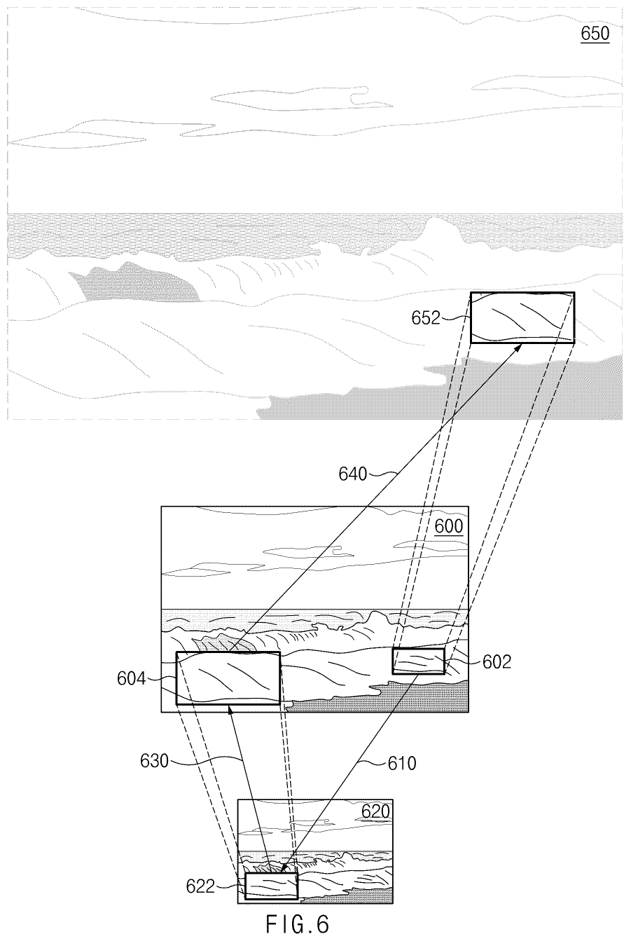

FIG. 6 is a diagram illustrating a state in which the high-resolution image generation method is applied to an actual image according to the embodiments of the present disclosure.

Referring to FIG. 6, the image processing device 100 may receive an input image 600, and may set a target area 602 of the input image 600. In one embodiment, the first image generator 110 of the image processing device 100 may generate a low-resolution image 620 based on the input image 600.

According to an embodiment, the reference area detector 120 of the image processing device 100 may search for an area most similar to the target area 602 from among areas of the low-resolution image 620, and may identify the most similar area as the reference area 622 (610). In one embodiment, the reference area 622 may have the same size as the target area 602. For example, the reference area 622 and the target area 602 may have the same size, but correspond to different images.

According to an embodiment, the correction area determiner 130 of the image processing device 100 may identify, as the correction area 604, an area corresponding to the reference area 622 from among the areas of the input image 600 (630). In one embodiment, the correction area 604 may correspond to an area located at coordinates obtained by multiplying a first coefficient by coordinates of the low-resolution image 620 of the reference area 622 from among coordinates of the input image 600. In one embodiment, the first coefficient may correspond to a value obtained by dividing the resolution of the input image 600 by the resolution of the low-resolution image 620. In FIG. 6, for convenience, it will be described that the correction area 604 is determined as the correction area most similar to the target area 602.

According to an embodiment, the second image generator 140 of the image processing device 100 may generate at least a portion of the high-resolution image 650 (640) by positioning the correction area 604 within an area 652 corresponding to the target area 602 from among areas of the high-resolution image 650 that have not yet been generated. In one embodiment, the second image generator 140 may determine, as the correction area 604, the area 652 corresponding to the target area 602 from among areas of the high-resolution image 650 that have not yet been generated. In one embodiment, the area 652 corresponding to the target area 602 may correspond to an area located at coordinates obtained by multiplying a third coefficient by the coordinates of the input image 600 of the target area 602 from among coordinates of the high-resolution image 650 that have not yet been generated. In one embodiment, the third coefficient may correspond to a value obtained by dividing the resolution of the high-resolution image 650 by the resolution of the input image 600. For example, the correction area 604 located in the area 652 corresponding to the target area 602 may correspond to an area in which the resolution, sharpness, and/or contrast of the target area 602 are improved. For example, the image of the area 652 corresponding to the target area 602 and the image of the correction area 604 from among the completed high-resolution images may correspond to the same image.

FIG. 7 is a diagram illustrating the target area, the reference area, and the correction area according to the embodiments of the present disclosure.

Referring to FIG. 7, the image processing device 100 may receive an input image 700, and may determine a target area 702 of the input image 700. In one embodiment, the first image generator 110 of the image processing device 100 may generate a first low-resolution image 710, a second low-resolution image 720, and a third low-resolution image 730 based on the input image 700. Although FIG. 7 shows only three low-resolution images for convenience, the scope or spirit of the present disclosure is not limited thereto, and the first image generator 110 may generate many more low-resolution images based on the input image 700.

According to an embodiment, the reference area detector 120 of the image processing device 100 may search for an area most similar to the target area 702 from among areas of the first low-resolution image 710, and may identify the most similar area as a first reference area 712. In one embodiment, the reference area detector 120 may search for an area most similar to the target area 702 from among areas of the second low-resolution image 720, and may identify the most similar area as a second reference area 722. In one embodiment, the reference area detector 120 may search for an area most similar to the target area 702 from among areas of the third low-resolution image 730, and may identify the most similar area as a third reference area 732.

According to an embodiment, the correction area determiner 130 of the image processing device 100 may identify an area corresponding to a reference area (e.g., 712, 722, or 732) from among areas of the input image 700 as a correction area (e.g., 704, 706, or 708). In one embodiment, the correction area determiner 130 may identify, as a first correction area 704, an area corresponding to a first reference area 712 from among areas of the input image 700. In one embodiment, the correction area determiner 130 may identify, as a second correction area 706, an area corresponding to a second reference area 722 from among areas of the input image 700. In one embodiment, the correction area determiner 130 may identify, as a third correction area 708, an area corresponding to a third reference area 732 from among areas of the input image 700.

According to an embodiment, the similarity determiner 134 of the image processing device 100 may determine one correction area most similar to the target area 702 from among the plurality of correction areas (e.g., 704, 706, and 708). For example, the similarity determiner 134 may determine, as the target correction area, one correction area most similar to the target area 702 from among the plurality of correction areas (e.g., 704, 706, and 708). In one embodiment, the similarity determiner 134 may perform first downscaling on the first correction area 704 to generate a first downscaling correction area, may perform second downscaling on the second correction area 706 to generate a second downscaling correction area, and may perform third downscaling on the third correction area 708 to generate a third downscaling correction area. In one embodiment, the first downscaling correction area, the second downscaling correction area, and the third downscaling correction area may have the same size as the target area 702.

According to an embodiment, the similarity determiner 134 may select a correction area (e.g., 704, 706, or 708) corresponding to a downscaling correction area that has the smallest difference value from among a first difference value in pixel data between the first downscaling correction area and the target area 702, a second difference value in pixel data between the second downscaling correction area and the target area 702, and a third difference value in pixel data between the third downscaling correction area and the target area 702. Further, the similarity determiner 134 may determine the selected correction area as a target correction area to be used to generate the high-resolution image (HR).

According to an embodiment, the target area 702, the correction area (e.g., 704, 706, or 708), and the downscaling correction area may satisfy a relationship as in Equation 6. In Equation 6, TA may represent the target area, CA may represent the correction area, ‘argmin’ may represent a function that outputs the smallest reference value from among the Euclidean distances of norm2, ‘A*CA’ may represent the downscaling correction area, ‘w’ may represent a weighting constant, a total variation (TV) may represent a total deformation factor, ‘A’ may represent a function to be used for downsampling, blurring, and warping operations, and ‘HCA’ may correspond to a correction area determined to be the correction area most similar to the target area. For example, ‘HCA’ may correspond to the target correction area.

$$HCA = {arg min}_{CA} {‖ TA - A * CA ‖}_{2}^{2} + ω TV ( CA ) \qquad [ Equation 6 ]$$

According to an embodiment, a preceding term of Equation 6 may correspond to a term for identifying a correction area most similar to the target area 702 from among a plurality of correction areas (e.g., 704, 706, or 708), and a following term of Equation 6 may correspond to a term that is combined with a loss function of the preceding term by applying a weight variable to the plurality of correction areas (e.g., 704, 706, or 708). In one embodiment, ‘argmin’ may correspond to a function for outputting a CA value that has the smallest pixel data value at the same pixel position of TA and the smallest pixel data value at the same pixel position of A*CA.

According to an embodiment, the similarity determiner 134 may determine one correction area that is most similar to the target area 702 from among the plurality of correction areas (e.g., 704, 706, and 708) as represented by Equation 6. For example, the plurality of correction areas (e.g., 704, 706, and 708) may correspond to CA of Equation 6, the target area 702 may correspond to TA of Equation 6, and the most similar correction area may correspond to HCA of Equation 6.

According to an embodiment, the target area 702 and the correction area (e.g., 704, 706, or 708) may satisfy relationships such as Equation 7, Equation 8, and Equation 9. In Equation 7, Equation 8, and Equation 9, ‘x’ may represent the target area, ‘y’ may represent the correction area, ‘n’ may represent the number of target areas, ‘i’ may represent the x-axis coordinate, ‘j’ may represent the y-axis coordinate, ‘V’ may represent a function that sums the amount of change between adjacent pixels of y, ‘E’ may represent the MSE average of ‘x’ and ‘y’, and ‘min [ ]’ may represent a function that outputs a reference value at which a resultant value obtained by the expression in parentheses is minimized.

$$V ( y ) = {\sum }_{i , j} \sqrt{{\vert {y}_{i + 1 , j} - {y}_{i , j} \vert}^{2} + {\vert {y}_{i , j + 1} - {y}_{i , j} \vert}^{2}} \qquad [ Equation 7 ]$$

$$E ( x , y ) = \frac{1}{n} {\sum }_{n} {( {x}_{n} - {y}_{n} )}^{2} . \qquad [ Equation 8 ]$$

$${min}_{y} [ E ( x , y ) + λ V ( y ) ] . \qquad [ Equation 9 ]$$

According to an embodiment, the similarity determiner 134 may determine only one correction area that is most similar to the target area 702 from among the plurality of correction areas (e.g., 704, 706, and 708) and is then TV (total variation)-processed, as represented by Equation 7, Equation 8, and Equation 9.

According to an embodiment, the first image generator 110 may generate a plurality of low-resolution images (e.g., 710, 720, 730). When a plurality of reference areas (e.g., 712, 722, 732) and a plurality of correction areas (e.g., 704, 706, 708) corresponding thereto are searched for based on the plurality of low-resolution images (e.g., 710, 720, and 730), the relationship between the low-resolution images (e.g., 710, 720, 730) and the high-resolution images may correspond to a simultaneous equation relationship with innumerable solutions. In one embodiment, the operation of the similarity determiner 134 may correspond to an operation of applying an objective function that finds an optimal solution among innumerable solutions by determining an optimal correction area from among several candidate correction areas (e.g., 704, 706, 708).

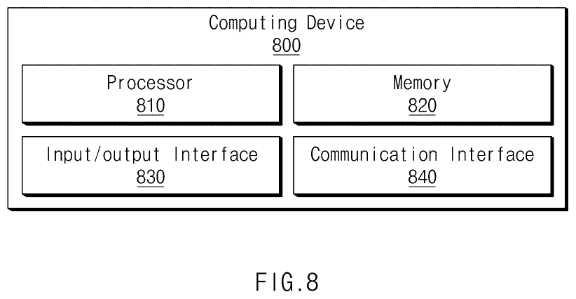

FIG. 8 is a block diagram showing a computing device 800 corresponding to the image processing device of FIG. 1.

Referring to FIG. 8, the computing device 800 may represent an embodiment of a hardware configuration for performing the operation of the image processing device 100 of FIG. 1.

The computing device 800 may be mounted on a chip that is independent from the chip on which the image sensing device is mounted. According to an embodiment, the chip on which the image sensing device is mounted and the chip on which the computing device 800 is mounted may be implemented in one package, for example, a multi-chip package (MCP), but the scope of the present disclosure is not limited thereto.

Additionally, the internal configuration or arrangement of the computing device 800 and the image sensing device may vary depending on the embodiment. For example, at least a portion of the image sensing device may be included in the computing device 800. Alternatively, at least a portion of the computing device 800 may be included in the image sensing device. In this case, at least a portion of the computing device 800 may be mounted together on a chip on which the image sensing device is mounted.

The computing device 800 may include a processor 810, a memory 820, an input/output interface 830, and a communication interface 840.

The processor 810 may process data and/or instructions required to perform the operations of the components (110, 120) of the image processing device 100 described in FIG. 1. That is, the processor 810 may refer to the image processing device 100, but the scope of the present disclosure is not limited thereto.

The memory 820 may store data and/or instructions required to perform operations of the components (110, 120) of the image processing device 100, and may be accessed by the processor 810. For example, the memory 820 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image processing device 100 disclosed in the present disclosure is recorded in the memory 820 and executed and processed by the processor 810, thereby implementing the operations of the image processing device 100.

The input/output interface 830 is an interface that connects an external input device (e.g., keyboard, mouse, touch panel, etc.) and/or an external output device (e.g., display) to the processor 810 to allow data to be transmitted and received.

The communication interface 840 is a component that can transmit and receive various data with an external device (e.g., an application processor, external memory, etc.), and may be a device that supports wired or wireless communication.

As is apparent from the above description, the image processing device according to the embodiments of the present disclosure may generate a high-contrast image even when DC offset noise occurs.

Even when a noise value is amplified by applying an analog gain or a digital gain to the image processing device in the low-illuminance environment, the image processing device may correct the amplified noise value.

The embodiments of the present disclosure may provide a variety of effects capable of being directly or indirectly recognized.

Although a number of illustrative embodiments have been described, it should be understood that modifications and enhancements to the disclosed embodiments and other embodiments can be devised based on what is described and/or illustrated in the present disclosure. Therefore, the scope of the present disclosure should not be limited to the above-described embodiments but should include the equivalents thereof. Furthermore, the embodiments may be combined to form additional embodiments.

What is claimed is:

1. An image processing device comprising:
a first image generator configured to generate a first image and a second image using an input image;
a reference area detector configured to search for a first reference area in the first image and a second reference area in the second image, wherein the first reference area is most similar to a target area of the input image in the first image, and the second reference area is most similar to the target area in the second image;
a correction area determiner configured to determine a target correction area from among a first correction area and a second correction area, wherein the target correction area is more similar to the target area, the first correction area is located in an area corresponding to the first reference area of the input image, and the second correction area is located in an area corresponding to the second reference area of the input image; and
a second image generator configured to generate a third image using the target correction area.

2. The image processing device according to claim 1, wherein:
each of the first image and the second image has a lower resolution than the input image; and
the third image has a higher resolution than the input image.

3. The image processing device according to claim 2, wherein the first image generator is configured to:
generate the first image by applying first downscaling to the input image; and
generate the second image by applying second downscaling to the input image.

4. The image processing device according to claim 3, wherein:
at least one of the first downscaling and the second downscaling includes at least one of warping, blurring, and downsampling.

5. The image processing device according to claim 3, wherein the correction area determiner is configured to:
compare each of a first downscaling correction area and a second downscaling correction area with the target area, wherein the first downscaling correction area is obtained when the first downscaling is applied to the first correction area, and the second downscaling correction area is obtained when the second downscaling is applied to the second correction area; and
determine the target correction area based on a result of the comparison.

6. The image processing device according to claim 5, wherein the correction area determiner is configured to:
determine, as the target correction area, a correction area having a smaller difference value from among a difference value in pixel data between the first downscaling correction area and the target area and a difference value in pixel data between the second downscaling correction area and the target area.

7. The image processing device according to claim 1, wherein the reference area detector is configured to:
search for the first and second reference areas based on a sum of absolute difference (SAD), normalized cross correlation (NCC), or mean square error (MSE) method on the first and second images.

8. The image processing device according to claim 1, wherein:
the first correction area corresponds to a coordinate that is obtained by multiplying a first coefficient by a first image coordinate of the first reference area from among coordinates of the input image; and
the second correction area corresponds to a coordinate that is obtained by multiplying a second coefficient by a second image coordinate of the second reference area from among coordinates of the input image.

9. The image processing device according to claim 8, wherein:
the first coefficient is obtained by dividing a resolution of the input image by a resolution of the first image; and
the second coefficient is obtained by dividing a resolution of the input image by a resolution of the second image.

10. The image processing device according to claim 9, wherein:
the second coefficient is the same as the first coefficient.

11. The image processing device according to claim 1, wherein the second image generator is configured to:
determine, as the target correction area, an area corresponding to the target area from among areas of the third image.

12. The image processing device according to claim 11, wherein:
the area corresponding to the target area corresponds to coordinates obtained by multiplying a third coefficient by coordinates of an input image of the target area from among coordinates of the third image.

13. The image processing device according to claim 12, wherein:
the third coefficient is obtained by dividing a resolution of the third image by a resolution of the input image.

14. The image processing device according to claim 12, wherein:
the third coefficient is obtained by dividing a resolution of the input image by a resolution of the first image or a resolution of the second image.

15. A method for processing an image signal, the method comprising:
generating a first image and a second image using an input image;
searching for a first reference area in the first image and a second reference area in the second image, wherein the first reference area is most similar to a target area of the input image in the first image, and the second reference area is most similar to the target area in the second image;
determining a target correction area from among a first correction area and a second correction area, wherein the target correction area is more similar to the target area, the first correction area is located in an area corresponding to the first reference area of the input image, and the second correction area is located in an area corresponding to the second reference area of the input image; and
generating a third image using the target correction area.

16. The method according to claim 15, wherein generating the first image and the second image includes:
generating the first image and the second image by applying at least one of warping, blurring, and downsampling to the input image.

17. The method according to claim 15, wherein determining the target correction area includes:
generating a first downscaling correction area and a second downscaling correction area by applying at least one of warping, blurring, and downsampling to the first correction area and the second correction area, respectively; and
determining, as the target correction area, a correction area having a smaller difference value from among a difference value in pixel data between the first downscaling correction area and the target area and a difference value in pixel data between the second downscaling correction area and the target area.

18. The method according to claim 15, wherein generating the third image includes:
determining, as the target correction area, an area corresponding to the target area from among areas of the third image.

19. An image processing device comprising:
a first image generator configured to generate a low-resolution image using an input image;
a reference area detector configured to search for a reference area in the low-resolution image, wherein the reference area is similar to a target area of the input image;
a similarity determiner configured to determine a similarity between the target area and a correction area located at a coordinate that is obtained by multiplying a scaling coefficient by low-resolution image coordinates of the reference area from among coordinates of the input image; and
a second image generator configured to generate a high-resolution image using the correction area based on the similarity between the target area and the correction area.

20. The image processing device according to claim 19, wherein the second image generator is configured to:
generate the high-resolution image when a difference value between pixel data of at least one pixel included in an area obtained by downscaling the correction area and pixel data of at least one pixel included in the target area is less than or equal to a preset threshold value.
